(19) United States
(12) Patent Application Publication
(10) Pub. No.: US 2025/0100561 A1
(43) Pub. Date: Mar. 27, 2025

(54) VEHICLE CONTROL METHOD AND APPARATUS, AND ELECTRONIC DEVICE

(71) Applicant: XG TECH PTE. LTD., Singapore (SG)

(72) Inventor: Jianfeng YU, Singapore (SG)

(73) Assignee: XG TECH PTE. LTD., Singapore (SG)

(21) Appl. No.: 18/970,035

(22) Filed: Dec. 5, 2024

(30) Foreign Application Priority Data
Aug. 20, 2024 (CN) 202411146884.1

(51) Int. Cl. B60W 50/00

(52) U.S. Cl. CPC B60W 50/0098

(57) ABSTRACT

Embodiments of the present disclosure disclose a vehicle control method and apparatus, a storage medium and an electronic device, wherein a vehicle is provided with a first chip and a second chip. The first chip supports an intelligent driving function, and the second chip at least supports an intelligent cockpit function. The vehicle control method includes: determining the current state of the first chip; in response to the current state being a first state, controlling the driving state of the vehicle through the first chip; and in response to the current state being a second state, controlling the driving state of the vehicle through the second chip. The embodiments of the present disclosure can prevent intelligent driving from being out of control and ensure the driving safety.

### CROSS-REFERENCE TO RELATED APPLICATION

The present disclosure claims priority to Chinese Patent Application No. 202411146884.1, filed on Aug. 20, 2024, entitled “vehicle control method and apparatus, storage medium and electronic device”, which is incorporated herein by reference in its entirety.

### FIELD OF THE PRESENT DISCLOSURE

The present disclosure relates to a driving technology, in particular to a vehicle control method and apparatus, a storage medium and an electronic device.

### BACKGROUND OF THE PRESENT DISCLOSURE

With the development of the driving technology, a driving subject gradually changes from a person to an intelligent driving system. A special chip for intelligent driving is an important part of the intelligent driving system. Once the special chip for intelligent driving cannot be operated normally, intelligent driving is out of control, thereby affecting driving safety.

### SUMMARY OF THE PRESENT DISCLOSURE

The present disclosure provides a vehicle control method and apparatus, a storage medium and an electronic device to prevent intelligent driving from being out of control and ensure driving safety.

According to one aspect of embodiments of the present disclosure, a vehicle control method is provided. The vehicle is provided with a first chip supporting an intelligent driving function and a second chip supporting an intelligent cockpit function at least.

The method includes:
determining the current state of the first chip;
in response to the current state being a first state, controlling, the first chip, the driving state of the vehicle;
in response to the current state being a second state, controlling, by the second chip, the driving state of the vehicle.

According to another aspect of the embodiment of the present disclosure, a vehicle control apparatus is provided, including:
a first chip configured for supporting an intelligent driving function;
a second chip configured for supporting an intelligent cockpit function at least;
a driven module configured for controlling a driving state of the vehicle under the driving of the first chip in response to a current state of the first chip as a first state;
and controlling the driving state of the vehicle under the driving of the second chip in response to the current state of the first chip as a second state.

According to another aspect of the embodiment of the present disclosure, a vehicle control apparatus is provided. The vehicle is provided with a first chip supporting an intelligent driving function and a second chip supporting an intelligent cockpit function at least.

The apparatus includes:
a determination module for determining a current state of the first chip;
a first control module for controlling the driving state of the vehicle by the first chip in response to the current state determined by the determination module as a first state;
a second control module for controlling the driving state of the vehicle by the second chip in response to the current state determined by the determination module as a second state.

According to another aspect of the embodiment of the present disclosure, a computer-readable storage medium is provided, which stores a computer program used for performing the above vehicle control method.

According to another aspect of the embodiment of the present disclosure, an electronic device is provided, which includes:
a processor;
a memory for storing executable instructions of the processor;

The processor is used for reading the executable instructions from the memory and executing the instructions to implement the above vehicle control method.

According to another aspect of the embodiment of the present disclosure, a computer program product is provided, which, when instructions on the computer program product are executed by a processor, causes the processor to execute the above vehicle control method.

Based on the vehicle control method and apparatus, the storage medium, the electronic device and the program product provided according to the above embodiments of the present disclosure, the first chip can be regarded as a main chip, and the second chip can be regarded as a slave chip. If the main chip can be operated normally, the driving state of the vehicle can be controlled through the main chip. If the main chip cannot be operated normally, the driving state of the vehicle can be controlled through the slave chip. In this way, a hot backup strategy can be used to effectively control the driving state of the vehicle, so as to prevent intelligent driving being out of control and ensure the driving safety. In addition, in the embodiments of the present disclosure, the main chip is a chip specifically used for supporting the automatic driving function, and the slave chip is a chip not specifically used for supporting the automatic driving function, but for at least supporting the intelligent cockpit function. That is, in the embodiments of the present disclosure, the hot backup can be realized through the reuse of the chip related to the intelligent cockpit function, thereby preventing intelligent driving being out of control at low cost and ensuring the driving safety.

### BRIEF DESCRIPTION OF THE DRAWINGS

FIG. 1 is a flow chart of a vehicle control method provided according to some exemplary embodiments of the present disclosure.

FIG. 2 is a flow chart of a vehicle control method provided according to some other exemplary embodiments of the present disclosure.

FIG. 3 is a flow chart of a vehicle control method provided according to some other exemplary embodiments of the present disclosure.

FIG. 4 is a flow chart of a vehicle control method provided according to some other exemplary embodiments of the present disclosure.

FIG. 5 is a flow chart of a vehicle control method provided according to some other exemplary embodiments of the present disclosure.

FIG. 6 is a structural schematic diagram of a vehicle control apparatus provided according to some exemplary embodiments of the present disclosure.

FIG. 7 is a structural schematic diagram of a vehicle control apparatus provided according to some other exemplary embodiments of the present disclosure.

FIG. 8 is a structural schematic diagram of a vehicle control apparatus provided according to some other exemplary embodiments of the present disclosure.

FIG. 9 is a structural schematic diagram of a first control module according to some exemplary embodiments of the present disclosure.

FIG. 10 is a structural schematic diagram of a vehicle control apparatus provided according to some other exemplary embodiments of the present disclosure.

FIG. 11 is a structural schematic diagram of an electronic device provided according to some exemplary embodiments of the present disclosure.

### DESCRIPTION OF THE EMBODIMENTS

To interpret the present disclosure, exemplary embodiments of the present disclosure will be described in detail below with reference to the drawings. Obviously, the embodiments described are only part of the embodiments of the present disclosure, not all embodiments. It is understood that the present disclosure is not limited to the exemplary embodiments.

It should be noted that, the relative arrangement of components and steps, numerical expressions and numerical values stated in the embodiments do not limit the scope of the present disclosure, unless specified otherwise.

### Overview of Application

The special chip for intelligent driving can be an important part of the intelligent driving system. The special chip for intelligent driving can be a chip specifically used for supporting the intelligent driving function.

It should be noted that once the special chip for intelligent driving cannot be operated normally due to software and/or hardware abnormalities, the intelligent driving will be out of control, thereby affecting the driving safety. For example, due to software and/or hardware abnormalities, the intelligent driving chip cannot correctly identify an obstacle that is too close in front of the vehicle and cannot conduct autonomous emergency braking (AEB), which may result in collision between the vehicle and the obstacle. For example, due to software and/or hardware abnormalities, the intelligent driving chip cannot correctly identify a traffic light in front of the vehicle, which may cause the vehicle to run past the red light.

How to prevent intelligent driving from being out of control and ensure the driving safety is a problem worthy of attention for those skilled in the art.

### Exemplary System

Backup is an important and necessary task in a computer system. It is understood that hot backup is a specific type of backup. Hot backup can refer to the backup during the operation of the system to ensure the continuity and availability of the system. In the embodiments of the present disclosure, the hot backup strategy can be used to control the driving state of the vehicle to prevent intelligent driving from being out of control and ensure the driving safety.

### Exemplary Method

An embodiment of the present disclosure provides a vehicle control method. The vehicle in the embodiment of the present disclosure may be provided with a first chip and a second chip. The first chip can support the intelligent driving function, i.e., achieving control of intelligent driving, and the second chip can support the intelligent cockpit function at least, i.e., achieving control of the intelligent cockpit.

Optionally, the first chip can be a chip specifically used for supporting the intelligent driving function, so the first chip can be a special chip for intelligent driving.

Optionally, the second chip can be a chip specifically used for supporting the intelligent cockpit function. Then, the second chip can be an intelligent cockpit chip. Or, the second chip can be a chip for supporting the intelligent driving function and the intelligent cockpit function, so the second chip can be a cockpit-driving integrated chip.

The intelligent driving function can include three parts: a perception function, a planning function and a control function. With the perception function, the environment around the vehicle, such as roads, static objects and dynamic objects, can be sensed. The static objects can include, for example, buildings, traffic lights, etc. The dynamic objects can include, for example, obstacles such as pedestrians, cyclists and other vehicles. The planning function can be used for making a plan according to the task needs of intelligent driving, e.g., planning whether to brake, whether to steer, whether to slow down, or planning an optimal driving path. The control function can be used for controlling an actuator in the vehicle to realize the braking, steering, deceleration and other actions of the vehicle.

The intelligent cockpit function can be used to achieve human-vehicle interaction, the interconnection between the vehicle and the outside, etc. in the cockpit of the vehicle. The intelligent cockpit function can be used for satisfying different needs of people in the vehicle through intelligent means, such as the needs of listening to music, listening to the radio and watching road conditions, which can bring more intelligent and safer interactive experience.

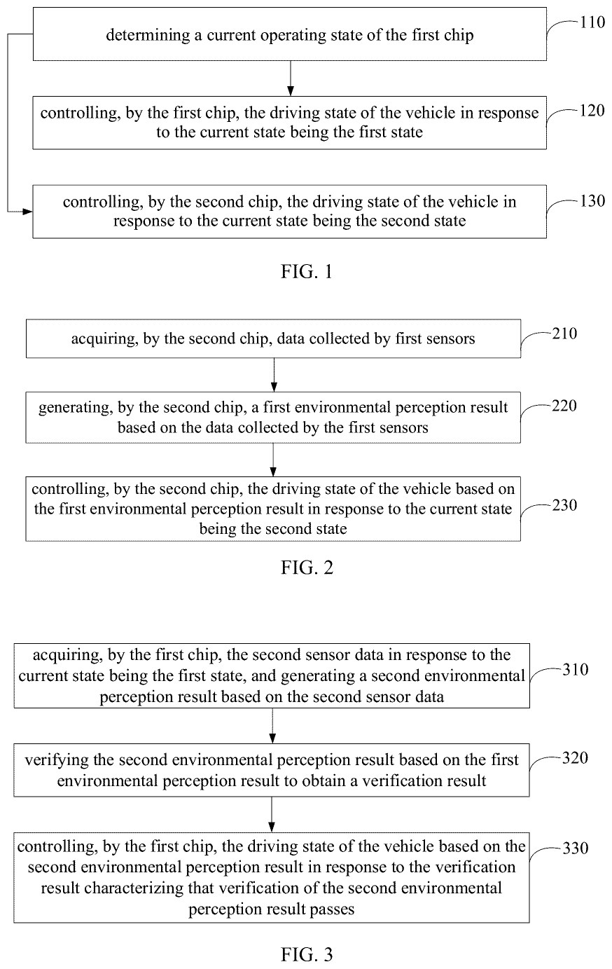

FIG. 1 is a flow chart of a vehicle control method provided according to some exemplary embodiments of the present disclosure. The method shown in FIG. 1 can include step 110, step 120, and step 130.

Step 110, determining a current operating state of the first chip.

Optionally, the hardware and software of the first chip can be detected periodically or irregularly to determine the current state of the first chip (also known as an operating state). The current state of the first chip can have two conditions, which are a first state and a second state. The first state can refer to a state in which the hardware and software of the first chip can be operated normally, and the first state can also be known as a normal state or an available state. The second state can be a state in which the hardware and/or software of the first chip cannot be operated normally, and the second state can also be known as an abnormal state or an unavailable state.

The above step 110 can be performed by a vehicle control unit. That is, the first chip determines the current operating state itself and generates corresponding state indication information, and the vehicle control unit can determine the current operating state of the first chip based on the state indication information generated by the first chip.

Step 120, controlling, by the first chip, the driving state of the vehicle in response to the current state being the first state.

Step 130, controlling, by the second chip, the driving state of the vehicle in response to the current state being the second state.

Optionally, if the current state of the first chip is the first state, because the software and hardware of the first chip can be operated normally, the driving state of the vehicle can be normally controlled by the first chip. In addition, the cockpit of the vehicle can be controlled by the second chip. If the current state of the first chip is the second state, because the software and/or hardware of the first chip cannot be operated normally, the driving state of the vehicle can be controlled without the first chip, and the driving state (also known as the drive state) of the vehicle can be controlled normally by the second chip.

The above steps 120-130 can be performed by the vehicle control unit. That is, if the current operating state of the first chip is the available state, the vehicle control unit can receive a first control instruction outputted by the first chip and control the driving state of the vehicle through the first control instruction. If the current operating state of the first chip is the unavailable state, the vehicle control unit can receive a second control instruction outputted by the second chip and control the driving state of the vehicle based on the second control instruction.

Optionally, if the current operating state of the first chip is the unavailable state, the vehicle control unit outputs state indication information corresponding to the unavailable state to the second chip in response to the current operating state being the unavailable state. In this way, the second chip determines that the first chip is unavailable, and the second control instruction can be output. The vehicle control unit receives the second control instruction outputted by the second chip, and then controls the driving state of the vehicle based on the second control instruction.

Optionally, the control of the driving state of the vehicle can include, for example, the control of the driving path, speed, acceleration, etc. of the vehicle, and the control of braking or not, steering or not, etc. of the vehicle. Cockpit control of the vehicle may include, for example, control of the display content of a center control screen and/or an instrument screen in the cockpit of the vehicle, and control of playing video and/or audio in the cockpit of the vehicle or not.

In the embodiment of the present disclosure, the first chip can be regarded as a main chip, and the second chip can be regarded as a slave chip. If the main chip can be operated normally, the driving state of the vehicle can be controlled by the main chip. If the main chip cannot be operated normally, the driving state of the vehicle can be controlled by the slave chip. In this way, a hot backup strategy can be used to effectively control the driving state of the vehicle, so as to prevent intelligent driving from being out of control and ensure the driving safety. In addition, in the embodiments of the present disclosure, the main chip is a chip specifically used for supporting the automatic driving function, and the slave chip is a chip not specifically used for supporting the automatic driving function, but for supporting the intelligent cockpit function at least. That is, in the embodiments of the present disclosure, the hot backup can be realized through the reuse of the chip related to the intelligent cockpit function, thereby preventing intelligent driving from being out of control of intelligent driving at low cost and ensuring the driving safety.

FIG. 2 is a flow chart of a vehicle control method provided according to some other exemplary embodiments of the present disclosure. The method shown in FIG. 2 can include step 210, step 220, and step 230. Optionally, step 230 may be used as an optional embodiment of step 130 of the present disclosure.

Step 210, acquiring, by the second chip, data collected by first sensors.

Optionally, the vehicle can be provided with a sensor device to assist in environmental perception. The sensor device can include N sensors, wherein N can be an integer greater than or equal to 2. The sensors can include but are not limited to cameras, radars, and positioning sensors. As an example, the camera can be a monocular camera or a binocular camera; the radar can be LiDAR or a millimeter wave radar; and the positioning sensor can be a positioning sensor based on a global navigation satellite system (GNSS) or based on a global positioning system (GPS).

Optionally, the data currently collected by N sensors respectively can periodically or irregularly acquired by the second chip, and these data can constitute the first sensor data. As an example, the first sensor data can include image data corresponding to the camera, point cloud data corresponding to the radar, and positioning data corresponding to the positioning sensor.

That is, one or more of the N sensors are recorded as first sensors, and the data collected by the first sensors may be acquired by the second chip, recorded as the first sensor data.

Step 220, generating, by the second chip, a first environmental perception result based on the data collected by the first sensors.

Optionally, the second chip can process the first sensor data by using an environmental perception algorithm to obtain the first environmental perception result. For example, the second chip can fuse the data corresponding to different sensors among the first sensor data, and generate the first environmental perception result based on the fusion result. Or, the second chip can process the data corresponding to different sensors among the first sensor data respectively to obtain the environmental perception results corresponding to different sensors respectively, and then fuse the environmental perception results corresponding to different sensors respectively to obtain the first environmental perception result.

Optionally, the first environmental perception result can include the environmental perception results corresponding to roads, static objects and dynamic objects respectively. The environmental perception results corresponding to the roads can include road types (for example, whether the road is a highway or an urban road), the number of lanes included in the roads, etc. The environmental perception results corresponding to the static objects can include the distances between buildings and the vehicle, the state of the traffic light (for example, whether a light is red or green), etc. The environmental perception results corresponding to the dynamic objects can include the positions, types, speed, behaviors, etc. of obstacles around the vehicle.

Step 230, controlling, by the second chip, the driving state of the vehicle based on the first environmental perception result in response to the current state being the second state.

Optionally, if the current state of the first chip is the second state, the driving state of the vehicle can be controlled without the first chip, and the driving state of the vehicle is controlled by the second chip. Moreover, the second chip can use the first environmental perception result as a basis for the control of the driving state of the vehicle. For example, if the first environmental perception result indicates that the vehicle is driven on a highway, the speed of the vehicle can be controlled by the second chip to keep the speed of the vehicle within a permitted speed range. For example, if the first environmental perception result indicates that there is an obstacle that is too close in front of the vehicle, the vehicle can be controlled by the second chip for automatic emergency braking.

The above step 230 can be performed by the vehicle control unit. That is, if the current operating state of the first chip is the unavailable state, the vehicle control unit receives the second control instruction generated by the second chip based on the first environmental perception result, and then controls the driving state of the vehicle by the second control instruction.

In the embodiment of the present disclosure, as soon as the second chip begins to operate, the second chip can begin to perform environmental perception. Once the first chip cannot be operated normally, the second chip can directly begin to control the driving state of the vehicle based on the existing environmental perception result (that is, the first environmental perception result). In this way, it is conducive to ensuring the seamless switching of intelligent driving and ensuring the driving safety.

In some embodiments, the second chip can also begin to perform environmental perception when the current state of the first chip is the second state. In some optional examples, step 220 can include:
generating, by the second chip, a first environmental perception result based on the first data of the first sensor data, in response to the current state being the first state the first data corresponding to the first sensors;
Or,
generating, by the second chip, a first environmental perception result based on all the data of the first sensor data, in response to the current state being the second state.

Optionally, a sensor that is more critical to environmental perception can be determined as the first sensor from the N sensors included in the sensor device. For example, if the N sensors are 6 cameras, which are a front camera, a left front camera, a right front camera, a rear camera, a left rear camera, and a right rear camera, then the first sensor can include only the front camera and the rear camera. If the current state of the first chip is the first state, the data corresponding to the first sensors can be screened from the first sensor data as the first data. The second chip can use the environmental perception algorithm to process the first data to obtain the first environmental perception result. Because the first environmental perception result generated by the second chip is not really used for decision-making and control related to intelligent driving when the first chip can be operated normally, only part of the data (that is, the first data) of the first sensor can be used in the process of generating the first environmental perception result by the second chip, which is conducive to saving resources and power consumption.

The second chip can receive the state indication information outputted by the vehicle control unit, and then determine the current operating state of the first chip.

That is, if the current operating state of the first chip is the available state, the second chip will not receive the state indication information corresponding to the unavailable state. At this time, the second chip acquires data collected by a first number of first sensors (that is, part of the data of the first sensor data).

Optionally, if the current state of the first chip is the second state, the second chip can use the environmental perception algorithm to process all the data of the first sensor data to obtain the first environmental perception result. Because the first environmental perception result generated by the second chip is really used for decision-making and control related to intelligent driving when the first chip cannot be operated normally, all the data of the first sensor data can be used in the process of generating the first environmental perception result by the second chip. In this way, the data used in the process of generating the first environmental perception result by the second chip is rich and comprehensive, which is conducive to ensuring the accuracy and reliability of the obtained first environmental perception result, and thus conducive to ensuring the reliability of intelligent driving.

That is, if the current operating state of the first chip is the unavailable state, the second chip will receive the state indication information corresponding to the unavailable state. At this time, data collected by a second number of first sensors acquired by the second chip, and the second number is greater than the first number. The second number can be the total number of the first sensors. At this time, all the data collected by the first sensors (that is, all the data of the first sensor data) is obtained.

FIG. 3 is a flow chart of a vehicle control method provided according to some other exemplary embodiments of the present disclosure. The method shown in FIG. 3 can include step 310, step 320, and step 330. Optionally, the combination of step 310 to step 330 can be used as an optional embodiment of step 120 of the present disclosure.

Step 310, acquiring, by the first chip, the second sensor data in response to the current state being the first state, and generating a second environmental perception result based on the second sensor data.

Optionally, the vehicle can be provided with a sensor device to assist in environmental perception. The sensor device can include N sensors (which can be known as second sensors), wherein N can be an integer greater than or equal to 2. If the current state of the first chip is the first state, the data currently collected by the N sensors respectively can periodically or irregularly acquired by the first chip, and these data can constitute the second sensor data. The first chip can also generate a second environmental perception result based on the second sensor data. The generation mode of the second environmental perception result and the composition of the second environmental perception result can refer to the relevant introduction of the first environmental perception result in the above, and will not be repeated here.

Step 320, verifying the second environmental perception result based on the first environmental perception result to obtain a verification result.

Optionally, a similarity algorithm can be used to determine the similarity between the first environmental perception result and the second environmental perception result. If the determined similarity is greater than preset similarity, the verification result can be used to characterize that verification of the second environmental perception result passes. If the determined similarity is less than or equal to the preset similarity, the verification result can be used to characterize that verification of the second environmental perception result fails. As an example, the preset similarity can be 75%, 80%, 85%, etc., which will not be fully listed here.

That is, the first chip can be connected with the second chip through an Ethernet interface, etc. to receive the first environmental perception result outputted by the second chip. Thereafter, the first chip can verify the second environmental perception result based on the first environmental perception result outputted by the second chip. Or the first environmental perception result may be stored in a register by the second chip, and be sent to the first chip by a trigger interrupt signal, so that the first environmental perception result may be read by the first chip from the register.

In some embodiments, a ratio of the determined similarity to the preset similarity can be calculated without comparing the sizes of the determined similarity with the preset similarity. If the calculated ratio is greater than a preset ratio, the verification result can be used to characterize that verification of the second environmental perception result passes. If the calculated ratio is less than or equal to the preset ratio, the verification result can be used to characterize that verification of the second environmental perception result fails. As an example, the preset ratio can be 0.8, 0.85, 0.9, etc., which will not be fully listed here.

Step 330, controlling, by the first chip, the driving state of the vehicle based on the second environmental perception result in response to the verification result characterizing that verification of the second environmental perception result passes.

Optionally, based on the second environmental perception result, the way to control the driving state of the vehicle through the first chip can refer to the relevant introduction of step 230 in the above, which will not be repeated here.

It should be noted that because the first environmental perception result and the second environmental perception result are both results obtained through environmental perception of the vehicle, the first environmental perception result and the second environmental perception result are theoretically consistent. In view of this, the first environmental perception result and the second environmental perception result can be compared to determine whether the first environmental perception result and the second environmental perception result are actually consistent. On this basis, it can be determined whether verification of the second environmental perception result passes. For example, if the similarity between the first environmental perception result and the second environmental perception result is high, it can be determined that verification of the second environmental perception result the second environmental perception result passes. When verification of the second environmental perception result the second environmental perception result passes, it can be determined that the accuracy of the second environmental perception result satisfies the requirements, and the second environmental perception result having the accuracy that satisfies the requirements is used for controlling the driving state of the vehicle, which is conducive to ensuring the driving safety.

That is, if the verification result represents that verification of the second environmental perception result the second environmental perception result passes, the first chip generates the first control instruction based on the second environmental perception result and outputs the first control instruction. Thus, the vehicle control unit receives the first control instruction outputted by the first chip, and uses the first control instruction to control the driving state of the vehicle.

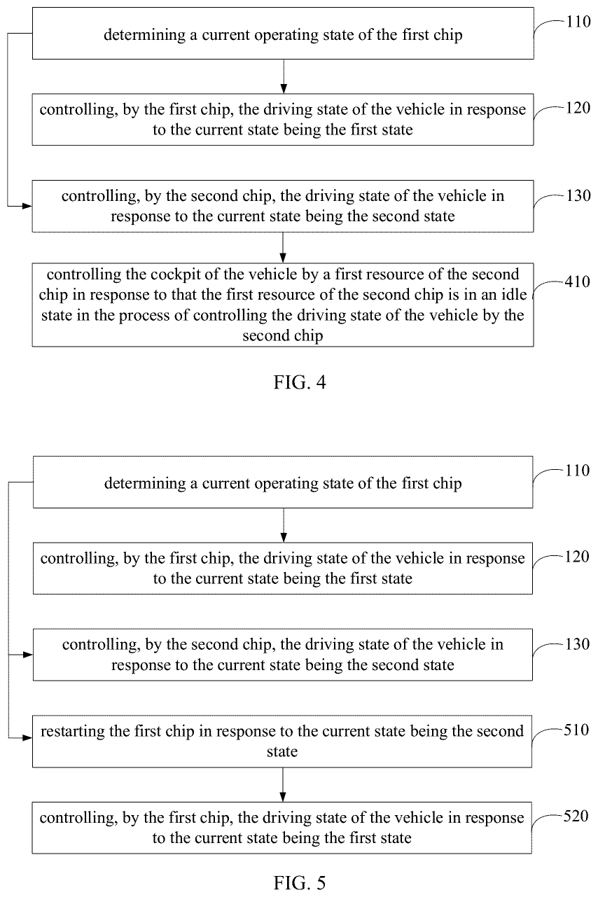

On the basis of the embodiments shown in FIG. 1, as shown in FIG. 4, the method provided according to the embodiments of the present disclosure can also include step 410.

Step 410, controlling the cockpit of the vehicle by a first resource of the second chip in response to that the first resource of the second chip is in an idle state in the process of controlling the driving state of the vehicle by the second chip.

Optionally, the second chip can be a high-performance system-on-a-chip (SOC), and the second chip can have sufficient resources. For example, the second chip can have sufficient hardware resources and software postures.

Optionally, if the current state of the first chip is the unavailable state, the intelligent cockpit function of the second chip can be restricted, and the resources (hardware resources) at the second chip can be preferably supplied to the control of the driving state of the vehicle. If the resources of the second chip are not fully occupied in the process of controlling the driving state of the vehicle by the second chip, these unoccupied resources are the first resources of the second chip in the idle state. For example, when 80% of the resources of the second chip are occupied in the process of controlling the driving state of the vehicle by the second chip, 20% of unoccupied resources can be used as the first resources of the second chip in the idle state. Then, the cockpit of the vehicle can be controlled through the first resources of the second chip. In this way, while using the intelligent driving function, the intelligent cockpit function can also be used, which can make full use of the resources and computing power of the second chip to improve the use experience of users.

That is, if the current operating state of the first chip is the unavailable state, the second chip generates and outputs the second control instruction based on the second resources (the resources for the control of the driving state of the vehicle provided preferably in the second chip), and generates and outputs a second cockpit control instruction based on the first resources. The driving state of the vehicle can be controlled by the vehicle control unit based on the second control instruction and the cockpit of the vehicle can be controlled based on the second cockpit control instruction. The cockpit of the vehicle can also be controlled by the second chip directly based on the second cockpit control instruction. The second cockpit control instruction can be used to implement several sub-functions of the cockpit control function. The second resources and the first resources form all the resources of the first chip.

Optionally, if the current operating state of the first chip is the available state, then the first chip outputs the first control instruction, and the vehicle control unit uses the first control instruction to realize the intelligent driving function. At this time, the second chip can output the first cockpit control instruction, and the vehicle control unit receives the first cockpit control instruction generated by the second chip and control the cockpit of the vehicle based on the first cockpit control instruction to realize the cockpit control function.

Based on the embodiments shown in FIG. 1, as shown in FIG. 5, the method provided according to the embodiments of the present disclosure can also include step 510 and step 520.

Step 510, restarting the first chip in response to the current state being the second state.

Optionally, if the current state of the first chip is the second state, a hardware restart can be performed for the first chip. If the hardware restart of the first chip is successful, a hardware self-test can be performed for the first chip. For example, the hardware self-test can be performed for the first chip by using a built-in self-test (BIST) algorithm. If the hardware self-test of the first chip is successful, it can be determined that the hardware of the first chip can be operated normally. At this time, the software of the first chip can be restarted.

Step 520, switching to control the driving state of the vehicle by the first chip after the successful restart of the first chip.

Optionally, if the software of the first chip is restarted successfully, it can be determined that the overall restart of the first chip is successful, and the first chip is restored to normal operation. Then, the control of the driving state of the vehicle through the second chip can be stopped, and is switched to the control of the driving state of the vehicle through the first chip.

Wherein the above steps 510-520 can be performed by the vehicle control unit. That is, if the current operating state of the first chip is the unavailable state, the vehicle control unit restarts the first chip. After the first chip is restarted successfully, the first chip outputs the first control instruction again. At this time, the vehicle control unit receives the first control instruction outputted by the first chip again, and controls the driving state of the vehicle based on the first control instruction.

Optionally, if the software of the first chip is not restarted successfully, it indicates that the first chip still cannot be operated normally. Then, the driving state of the vehicle can be controlled continuously through the second chip, and moreover, the first chip can be restarted again.

In the embodiments of the present disclosure, when the current state of the first chip is the second state, the driving state of the vehicle can be controlled by the second chip. Meanwhile, the first chip can be attempted to restore to normal by the restarting operation. Once the first chip is restored to normal operation, it can be switched to the control of the driving state of the vehicle by the first chip. At this time, the resources at the second chip can be preferably provided to the cockpit control of the vehicle. Because the first chip is a chip specifically used for supporting the intelligent driving function, it is conducive to ensuring the reliability of intelligent driving, and can avoid restrictions on intelligent cockpit functions as much as possible, which is conducive to ensuring the use experience of users.

To sum up, the embodiments of the present disclosure can effectively control the driving state and the cockpit of the vehicle, prevent intelligent driving from being out of control, and ensure the driving safety and the use experience of users.

In another exemplary embodiment of the present disclosure, the vehicle control method includes the following steps.

Step 60a, determining, by the vehicle control unit, the current operating state of the first chip based on the state indication information generated by the first chip for indicating the current operating state of the first chip.

In this step, the first chip monitors the current operating state in real time and generates the corresponding state indication information. The first chip outputs the state indication information, and the vehicle control unit receives the state indication information to determine the current operating state of the first chip.

Step 60b, jumping to step 60c in response to the current operating state being the available state. In response to the current operating state being the unavailable state, the state indication information corresponding to the unavailable state is outputted by the vehicle control unit to the second chip. Jump to step 60h.

Step 60c, acquiring, by the second chip, data collected by a first number of first sensors. A first environmental perception result is generated by the second chip based on the data collected by the first number of first sensors.

In this step, the second chip does not receive the state indication information corresponding to the unavailable state and outputted by the vehicle control unit. Therefore, the second chip determines that the current operating state of the first chip is the available state. At this time, the second chip acquires the data collected by the first number of first sensors and generates the first environmental perception result.

Step 60d, acquiring, by the first chip, the data collected by the second sensors, and generating a second environmental perception result based on the data collected by the second sensors.

In this step, the second chip in the available state acquires the data collected by the second sensors and generates the second environmental perception result.

Step 60e, receiving, by the first chip, the first environmental perception result outputted by the second chip, wherein the first chip is connected with the second chip. The second environmental perception result is verified by the first chip based on the first environmental perception result to obtain a verification result. The first control instruction is generated and outputted by the first chip based on the second environmental perception result in response to the verification result characterizing that verification of the second environmental perception result the second environmental perception result passes.

In this step, the first chip compares the first environmental perception result with the second environmental perception result to obtain the verification result. If the verification is passed, the second environmental perception result is considered accurate, and the first control instruction is generated and outputted based on the second environmental perception result.

Step 60f, receiving the first control instruction outputted by the first chip and controlling the driving state of the vehicle by the vehicle control unit based on the first control instruction.

In this step, the vehicle control unit controls the driving state of the vehicle based on the first control instruction outputted by the first chip. In this way, when the first chip is in the available state, the vehicle control unit uses the first chip to achieve the intelligent driving function.

Step 60g, receiving the first cockpit control instruction generated by the second chip and controlling the cockpit of the vehicle by the vehicle control unit based on the first cockpit control instruction.

In this step, the vehicle control unit controls the cockpit of the vehicle based on the first cockpit control instruction outputted by the second chip. In this way, when the first chip is in the available state, the vehicle control unit uses the second chip to achieve the cockpit control function.

Step 60h, receiving the state indication information corresponding to the unavailable state, and acquiring the data collected by the second number of the first sensors by the second chip, the second number being greater than the first number. The first environmental perception result is generated by the second chip based on the data collected by the second number of first sensors.

In this step, the second chip receives the state indication information corresponding to the unavailable state and outputted by the vehicle control unit. Therefore, the second chip determines that the current operating state of the first chip is the unavailable state. At this time, the second chip acquires the data collected by the second number of first sensors and generates the first environmental perception result.

Step 60i, receiving the second control instruction generated by the second chip based on the first environmental perception result, and controlling the driving state of the vehicle by the vehicle control unit based on the second control instruction.

In this step, when the resources of the second chip are not fully occupied, the second resource of the second chip generates the second control instruction based on the first environmental perception result, and outputs the second control instruction. The vehicle control unit receives the second control instruction outputted by the second chip and controls the driving state of the vehicle based on the second control instruction. In this way, when the first chip is in the unavailable state, the vehicle control unit uses the second chip to achieve the intelligent driving function.

Step 60j, receiving the second cockpit control instruction generated by the second chip based on the second resource, and controlling the cockpit of the vehicle by the vehicle control unit based on the second cockpit control instruction.

In this step, the second chip generates and outputs a second cockpit control instruction based on the first resource. The vehicle control unit receives the second cockpit control instruction outputted by the second chip, and controls the cockpit of the vehicle based on the second cockpit control instruction. In this way, when the first chip is in the unavailable state, the vehicle control unit continues to use the second chip to achieve the cockpit function. Step 60k, the vehicle control unit restarts the first chip.

In this step, the vehicle control unit controls the restart of the first chip.

Step 60l, receiving the first control instruction outputted by the first chip again after the first chip is restarted successfully, and controlling the driving state of the vehicle by the vehicle control unit based on the first control instruction.

In this step, after the first chip is restarted successfully, the first chip is restored to the available state and outputs the state indication information to the vehicle control unit. The first chip generates the first control instruction again, and the vehicle control unit receives the first control instruction outputted by the first chip again, and controls the driving state of the vehicle based on the first control instruction. For details, steps 60a-60g can be referred, which will not be repeated here.

It should be understood that the size of the sequence number of each step in the above embodiments does not mean the order of execution, and the order of execution of each process shall be determined by the function and the internal logic, and shall not constitute any limitation on the implementation process of the embodiments of the present invention.

### Exemplary Apparatus

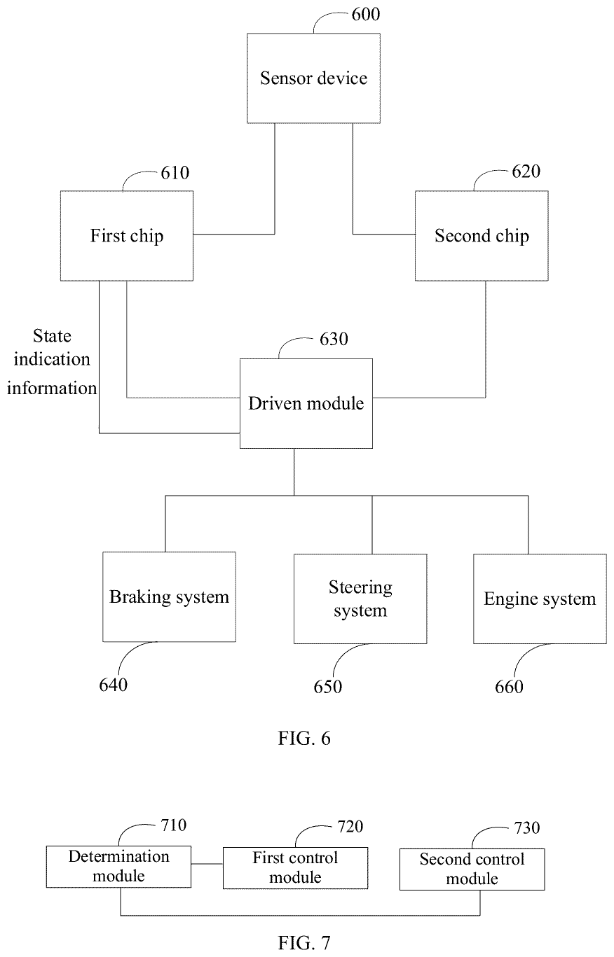

FIG. 6 is a structural schematic diagram of a vehicle control apparatus provided according to some exemplary embodiments of the present disclosure. The apparatus shown in FIG. 6 can include:
a first chip 610, wherein the first chip 610 supports the intelligent driving function;
a second chip 620, wherein the second chip 620 supports the intelligent cockpit function at least;
a driven module 630 (also known as the vehicle control unit), wherein the driven module 630 is configured for controlling the driving state of the vehicle under the driving of the first chip 610 in response to the current state of the first chip 610 as the first state; and the driven module 630 is configured for controlling the driving state of the vehicle under the driving of the second chip 620 in response to the current state of the first chip 610 as the second state.

Optionally, the vehicle can be an electric vehicle, and the driven module 630 can include a vehicle control unit (VCU) for the electric vehicle. The driven module 630 can be electrically connected with the first chip 610 and the second chip 620 respectively. For example, the driven module 630 can be electrically connected with the first chip 610 and the second chip 620 through a controller area network (CAN) bus.

Optionally, the first chip 610 can acquire the data collected by a sensor device 600 to obtain the second sensor data above. Wherein the sensor device 600 can include a millimeter wave radar, a LIDAR and/or a camera, etc. Based on the second sensor data, the first chip 610 can perform perception and planning operation. It is assumed that at time t1, a driving path planned by the first chip 610 is L1; at time t2, which is later than time t1 and very close to time t1, the driving path planned by the first chip 610 is L2; the difference between L1 and L2 is too large; and there is no overlap at all. Then, it can be determined that the software of the first chip 610 cannot be operated normally. It is assumed that it is determined that there are obstacles within a certain distance in front of the vehicle based on the image data corresponding to the camera in the second sensor data, and it is determined that there is no obstacle within a certain distance in front of the vehicle based on the point cloud data corresponding to the LiDAR in the second sensor data. Then, it can be determined that the software of the first chip 610 cannot be operated normally. On this basis, it can be determined whether the current state of the first chip 610 is the first state or the second state. The first chip 610 can send the state indication information for indicating the current state of the first chip 610 to the driven module 630.

If the current state of the first chip 610 is the first state, the driven module 630 can receive the control instructions from the first chip 610, and control a braking system 640, a steering system 650, an engine system 660, etc. according to the received control instructions, so as to make braking, steering, speed adjustment, etc. of the vehicle.

If the current state of the first chip 610 is the second state, the driven module 630 can receive the control instructions from the second chip 620, and control the braking system 640, the steering system 650, the engine system 660, etc. according to the received control instructions, so as to make braking, steering, speed adjustment, etc. of the vehicle.

In some embodiments, the vehicle may also not be an electric vehicle, and can be, for example, a fuel vehicle. In this case, the driven module 630 may not be a VCU, but a controller capable of controlling the braking system 640, the steering system 650, the engine system 660, etc. in the fuel vehicle.

In the embodiment of the present disclosure, the first chip 610 can be regarded as a main chip, and the second chip 620 can be regarded as a slave chip. If the main chip can be operated normally, the driving state of the vehicle can be controlled through the main chip. If the main chip cannot be operated normally, the driving state of the vehicle can be controlled through the slave chip. In this way, a hot backup strategy can be used to effectively control the driving state of the vehicle, so as to prevent intelligent driving from being out of control and ensure the driving safety. In addition, in the embodiments of the present disclosure, the main chip is a chip specifically used for supporting the automatic driving function, and the slave chip is a chip not specifically used for supporting the automatic driving function, but for supporting the intelligent cockpit function at least. That is, in the embodiments of the present disclosure, the hot backup can be realized through the reuse of the chip related to the intelligent cockpit function, thereby preventing intelligent driving from being out of control at low cost and ensuring the driving safety.

In some optional examples, the driven module 630 is configured for outputting the state indication information corresponding to the unavailable state to the second chip 620 in response to the current operating state being the unavailable state, receiving the second control instruction outputted by the second chip 620, and controlling the driving state of the vehicle based on the second control instruction.

In some optional examples, the second chip 620 is configured for acquiring the data collected by the first sensors and generating the first environmental perception result based on the data collected by the first sensors. The driven module 630 is configured for receiving the second control instruction generated by the second chip 620 based on the first environmental perception result in response to the current operating state being the unavailable state.

In some optional examples, the second chip 620 is configured for acquiring the data collected by the first number of first sensors when the state indication information corresponding to the unavailable state is not received. The second chip 620 is further configured for receiving the state indication information corresponding to the unavailable state, and acquiring the data collected by the second number of the first sensors. The second number is greater than the first number.

In some optional examples, the first chip 610 is configured for acquiring the data collected by the second sensors and generating the second environmental perception result based on the data collected by the second sensors; receiving the first environmental perception result outputted by the second chip 620, wherein the first chip 610 is connected with the second chip 620; verifying the second environmental perception result based on the first environmental perception result to obtain a verification result; and generating and outputting the first control instruction based on the second environmental perception result in response to the verification result characterizing that verification of the second environmental perception result the second environmental perception result passes.

In some optional examples, the driven module 630 is configured for receiving a first cockpit control instruction generated by the second chip 620 in response to the current operating state being the unavailable state, and controlling the cockpit of the vehicle based on the first cockpit control instruction.

In some optional examples, the driven module 630 is configured for receiving a second control instruction generated by the second chip 620 based on the second resource in response to the current operating state being the unavailable state, receiving a second cockpit control instruction generated by the second chip 620 based on the first resource, and controlling the cockpit of the vehicle based on the second cockpit control instruction.

In some optional examples, the driven module 630 is configured for restarting the first chip 610 in response to the current operating state being the unavailable state; and receiving the first control instruction outputted by the first chip 610 again after the first chip 610 is restarted successfully, and controlling the driving state of the vehicle based on the first control instruction.

It should be noted that the detailed description of each module in the vehicle control device provided according to the exemplary embodiments of the present disclosure is referred to the above exemplary methods and will not be repeated here.

FIG. 7 is a structural schematic diagram of a vehicle control apparatus provided according to some other exemplary embodiments of the present disclosure. The vehicle is provided with a first chip and a second chip. The first chip supports the intelligent driving function, and the second chip supports at least the intelligent cockpit function. The apparatus shown in FIG. 7 can include:
a determination module 710 configured for determining the current state of the first chip;
a first control module 720 configured for controlling the driving state of the vehicle by the first chip in response to the current state determined by the determination module 710 as the first state;
a second control module 730 configured for controlling the driving state of the vehicle by the second chip in response to the current state determined by the determination module 710 as the second state.

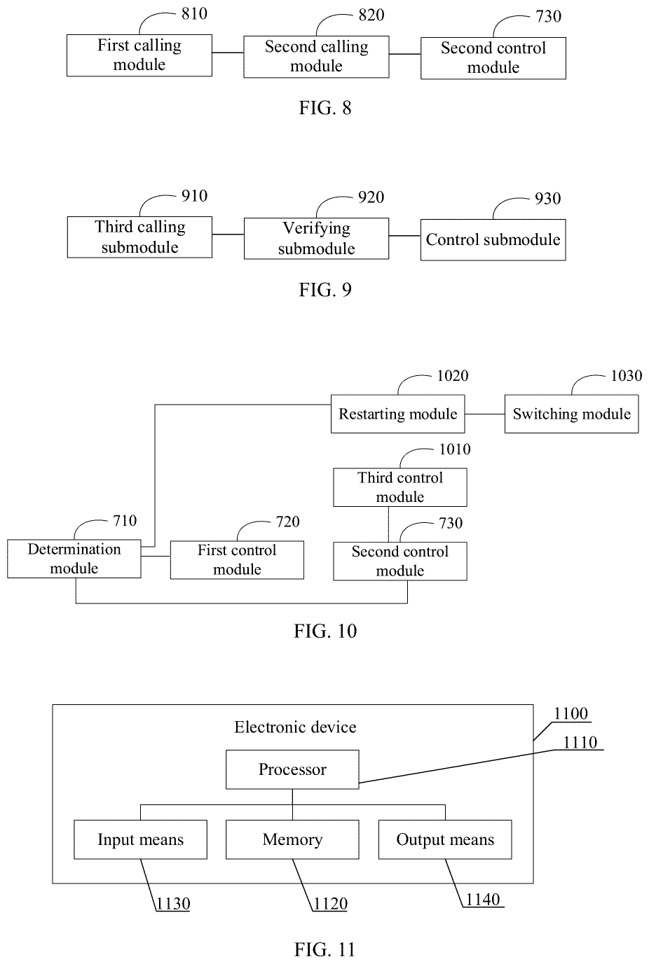

In some optional examples, as shown in FIG. 8, the apparatus provided according to the embodiments of the present disclosure can also include:
a first calling module 810 configured for calling the second chip to acquire first sensor data;
a second calling module 820 configured for calling the second chip to generate a first environmental perception result based on the first sensor data;
a second control module 730 configured for calling the first environmental perception result generated by the second chip based on the second calling module 820 in response to the current state determined by the determination module 710 as the second state, and controlling the driving state of the vehicle through the second chip.

In some optional examples, the first calling module 810 includes:
a first calling submodule for calling the second chip to generate the first environmental perception result based on the first data of the first sensor data in response to the current state determined by the determination module 710 as the first state, wherein the first data corresponds to the first sensors;
or,
a second calling submodule for calling the second chip to generate the first environmental perception result based on all the data of the first sensor data in response to the current state determined by the determination module 710 as the second state.

In some optional examples, as shown in FIG. 9, the first control module 720 includes:
a third calling submodule 910 configured for calling the first chip to acquire second sensor data and generate a second environmental perception result based on the second sensor data in response to the current state determined by the determination module 710 as the first state;
a verification submodule 920 configured for calling the first environmental perception result generated by the second chip based on the second calling module 820 and calling the second environmental perception result obtained by the first chip for the third calling submodule 910 for verification to obtain a verification result;
a control submodule 930 configured for calling the second environmental perception result obtained by the first chip based on the third calling submodule 910 in response to the verification result obtained by the verification submodule 920 characterizing that verification of the second environmental perception result the second environmental perception result passes, and controlling the driving state of the vehicle through the first chip.

In some optional examples, as shown in FIG. 10, the apparatus provided according to the embodiments of the present disclosure can also include:
a third control module 1010 configured for controlling the cockpit of the vehicle through the first resource of the second chip in response to that the first resource of the second chip is in an idle state in the process of controlling the driving state of the vehicle through the second chip.

In some optional examples, as shown in FIG. 10, the apparatus provided according to the embodiments of the present disclosure can also include:
a restarting module 1020 configured for restarting the first chip in response to the current state determined by the determination module 710 as the second state;
a switching module 1030 configured for switching to control the driving state of the vehicle through the first chip after the first chip is successfully restarted by the restarting module 1020.

In the apparatus of the present disclosure, various optional embodiments, optional implementation modes and optional examples disclosed above can be flexibly selected and combined as required, so as to achieve the corresponding functions and effects, which will not be listed one by one by the present disclosure.

### Exemplary Electronic Device

FIG. 11 illustrates a block diagram of an electronic device according to the embodiments of the present disclosure. The electronic device 1100 includes one or at least one processor 1110 and a memory 1120.

The processor 1110 can be a central processing unit (CPU) or some other forms of processing units having data processing capabilities and/or instruction execution capabilities, and can control other assemblies in the electronic device 1100 to perform the desired functions.

The memory 1120 can include one or more computer program products. The computer program products can include various forms of computer-readable storage media, such as volatile memories and/or non-volatile memories. The volatile memories can include, for example, a random access memory (RAM) and/or a cache. The non-volatile memories can include, for example, a read-only memory (ROM), a hard disk, a flash memory, etc. One or more computer program instructions can be stored on the computer-readable storage media. The processor 1110 can run one or more computer program instructions to implement the methods of various embodiments of the present disclosure described above and/or other desired functions.

In one example, the electronic device 1100 can also include: an input means 1130 and an output means 1140, and these assemblies are interconnected by a bus system and/or other forms of connection mechanisms (not shown).

The input means 1130 can also include, for example, a keyboard, a mouse, various sensors, a touch screen, etc.

The output means 1140 can output all kinds of information to the outside, and can include, for example, a display, a speaker, a printer, a communication network, a remote output device connected thereto, etc.

Of course, for simplicity, FIG. 11 only shows some of the assemblies relevant to the present disclosure in the electronic device 1100, and omits assemblies such as buses, input/output interfaces, etc. In addition, according to the specific application conditions, the electronic device 1100 can also include any other appropriate assemblies.

### Exemplary Computer Program Product and Computer-Readable Storage Medium

In addition to the above methods and devices, embodiments of the present disclosure can also be a computer program product that includes computer program instructions which, when run by a processor, cause the processor to perform the steps in the method described in the above “Exemplary Method” part of this description according to various embodiments of the present disclosure.

The computer program product may be written into program codes for performing the operation of embodiments of the present disclosure in one or any combination of more of programming languages. The programming languages include object-oriented programming languages, such as Java, C++, etc., and also include conventional procedural programming languages, such as the “C” language or similar programming languages. The program codes can be executed entirely on a user computing device, partly on a user device, as a stand-alone software package, partly on the user computing device and partly on a remote computing device, or entirely on the remote computing device or a server.

In addition, the embodiments of the present disclosure can also be computer-readable storage medium on which computer program instructions are stored. The computer program instructions, when run by the processor, cause the processor to perform the steps in the method described in the above “Exemplary Method” part of this description according to various embodiments of the present disclosure.

The computer-readable storage medium can adopt one or any combination of more of readable media. The readable media can be a readable signal medium or a readable storage medium. The readable storage media may, for example, include, but are not limited to, electrical, magnetic, optical, electromagnetic, infrared, or semiconductor systems, apparatuses or devices, or any combination of the above. More specific examples of the readable storage media (a non-exhaustive list) include: electrical connection having one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical memory device, a magnetic memory device, or any appropriate combination of the above.

The above describes the basic principles of the present disclosure in conjunction with specific embodiments. However, the advantages, strengths, effects, etc. mentioned in the present disclosure are only examples and not limitations, and these advantages, strengths, effects, etc. shall not be considered to be necessary for each embodiment of the present disclosure. The specific details disclosed above are for examples and convenience for understanding only, and not for limitations. The present disclosure should not be limited to the above details for implementation.

Those skilled in the art can implement various modifications and variations to the present disclosure without departing from the spirit and scope of the present application. Thus, the present disclosure is intended to include the modifications and variations if the amendments and variations of the present application belong to claims of the present disclosure and the equivalent technical scope.

What is claimed is:

1. A vehicle control method, wherein the vehicle is provided with a first chip supporting an intelligent driving function and a second chip supporting an intelligent cockpit function at least;
wherein the method comprises:
determining, by a vehicle control unit, a current operating state of the first chip based on state indication information generated by the first chip for indicating the current operating state of the first chip;
receiving, by the vehicle control unit, a first control instruction outputted by the first chip in response to the current operating state being an available state, and controlling a driving state of the vehicle based on the first control instruction; and
receiving, by the vehicle control unit, a second control instruction outputted by the second chip in response to the current operating state being an unavailable state, and controlling the driving state of the vehicle based on the second control instruction.

2. The method according to claim 1, wherein receiving, by the vehicle control unit, a second control instruction outputted by the second chip in response to the current operating state being an unavailable state, and controlling the driving state of the vehicle based on the second control instruction comprises:
outputting, by the vehicle control unit, state indication information corresponding to the unavailable state in response to the current operating state being the unavailable state; and
receiving, by the vehicle control unit, the second control instruction outputted by the second chip, and controlling the driving state of the vehicle based on the second control instruction.

3. The method according to claim 2, further comprising:
acquiring, by the second chip, data collected by first sensors; and
generating, by the second chip, a first environmental perception result based on the data collected by the first sensors;
wherein receiving, by the vehicle control unit, a second control instruction outputted by the second chip in response to the current operating state being an unavailable state, further comprises:
receiving, by the vehicle control unit, the second control instruction generated by the second chip based on the first environmental perception result in response to the current operating state being the unavailable state.

4. The method according to claim 3, wherein acquiring, by the second chip, the data collected by first sensors comprises:
acquiring, by the second chip, data collected by a first number of first sensors when the state indication information corresponding to the unavailable state is not received; and
receiving, by the second chip, the state indication information corresponding to the unavailable state, and acquiring data collected by a second number of the first sensors, the second number being greater than the first number.

5. The method according to claim 3, wherein before receiving, by the vehicle control unit, the first control instruction outputted by the first chip in response to the operating state being an available state, the method further comprises:
acquiring, by the first chip, data collected by second sensors and generating a second environmental perception result based on the data collected by the second sensors;
receiving, by the first chip, the first environmental perception result outputted by the second chip;
verifying, by the first chip, the second environmental perception result based on the first environmental perception result, to obtain a verification result; and
generating and outputting, by the first chip, the first control instruction based on the second environmental perception result in response to the verification result characterizing that verification of the second environmental perception result passes.

6. The method according to claim 1, further comprising:
receiving, by the vehicle control unit, a first cockpit control instruction generated by the second chip in response to the current operating state being the available state, and controlling a cockpit of the vehicle based on the first cockpit control instruction.

7. The method according to claim 1, further comprising:
receiving, by the vehicle control unit, the second control instruction generated by the second chip based on a second resource in response to the current operating state being the unavailable state, receiving a second cockpit control instruction generated by the second chip based on a first resource, and controlling the cockpit of the vehicle based on the second cockpit control instruction.

8. The method according to claim 1, further comprising:
restarting, by the vehicle control unit, the first chip in response to the current operating state being the unavailable state; and
receiving, by the vehicle control unit, the first control instruction outputted by the first chip again after the first chip is restarted successfully, and controlling the driving state of the vehicle based on the first control instruction.

9. A vehicle control apparatus, comprising:
a first chip configured for supporting an intelligent driving function;
a second chip configured for supporting an intelligent cockpit function at least; and
a vehicle control unit configured for determining a current operating state of the first chip based on state indication information generated by the first chip for indicating the current operating state of the first chip; receiving a first control instruction outputted by the first chip in response to the current operating state being an available state, and controlling a driving state of the vehicle based on the first control instruction; and receiving a second control instruction outputted by the second chip in response to the current operating state being an unavailable state, and controlling the driving state of the vehicle based on the second control instruction.

10. The apparatus according to claim 9, wherein
the vehicle control unit is configured for outputting the state indication information corresponding to the unavailable state to the second chip in response to the current operating state being the unavailable state; and receiving the second control instruction outputted by the second chip, and controlling the driving state of the vehicle based on the second control instruction.

11. The apparatus according to claim 10, wherein
the second chip is configured for acquiring data collected by first sensors and generating a first environmental perception result based on the data collected by the first sensors;
the vehicle control unit is configured for receiving the second control instruction generated by the second chip based on the first environmental perception result in response to the current operating state being the unavailable state.

12. The apparatus according to claim 11, wherein
the second chip is configured for acquiring data collected by a first number of first sensors when the state indication information corresponding to the unavailable state is not received;
the second chip is further configured for receiving the state indication information corresponding to the unavailable state and acquiring the data collected by a second number of the first sensors, the second number being greater than the first number.

13. The apparatus according to claim 11, wherein the first chip is configured for:
acquiring data collected by second sensors and generating a second environmental perception result based on the data collected by the second sensors; receiving the first environmental perception result outputted by the second chip; verifying the second environmental perception result based on the first environmental perception result to obtain a verification result; and generating and outputting the first control instruction based on the second environmental perception result in response to the verification result characterizing that verification of the second environmental perception result passes.

14. The apparatus according to claim 9, wherein
the vehicle control unit is configured for receiving a first cockpit control instruction generated by the second chip in response to the current operating state being the available state, and controlling a cockpit of the vehicle based on the first cockpit control instruction.

15. The apparatus according to claim 9, wherein the vehicle control unit is configured for:
receiving the second control instruction generated by the second chip based on a second resource in response to the current operating state being the unavailable state, and
receiving a second cockpit control instruction generated by the second chip based on a first resource, and controlling the cockpit of the vehicle based on the second cockpit control instruction.

16. The apparatus according to claim 9, wherein
the vehicle control unit is configured for restarting the first chip in response to the current operating state being the unavailable state; and receiving the first control instruction outputted by the first chip again after the first chip is restarted successfully, and controlling the driving state of the vehicle based on the first control instruction.

17. An electronic device, comprising:
a processor;
a memory for storing executable instructions of the processor;
wherein the processor is used for reading the executable instructions from the memory and executing the instructions to implement the following steps:
determining, by a vehicle control unit, a current operating state of a first chip supporting an intelligent driving function based on state indication information generated by the first chip for indicating the current operating state of the first chip;
receiving, by the vehicle control unit, a first control instruction outputted by the first chip in response to the current operating state being an available state, and controlling a driving state of the vehicle based on the first control instruction; and
receiving, by the vehicle control unit, a second control instruction outputted by the second chip supporting an intelligent cockpit function at least in response to the current operating state being an unavailable state, and controlling the driving state of the vehicle based on the second control instruction.

18. The electronic device according to claim 17, wherein receiving, by the vehicle control unit, a second control instruction outputted by the second chip in response to the current operating state being an unavailable state, and controlling the driving state of the vehicle based on the second control instruction comprises:
outputting, by the vehicle control unit, state indication information corresponding to the unavailable state in response to the current operating state being the unavailable state; and
receiving, by the vehicle control unit, the second control instruction outputted by the second chip, and controlling the driving state of the vehicle based on the second control instruction.

19. The electronic device according to claim 18, further comprising:
acquiring, by the second chip, data collected by first sensors; and
generating, by the second chip, a first environmental perception result based on the data collected by the first sensors;
wherein receiving, by the vehicle control unit, a second control instruction outputted by the second chip in response to the current operating state being an unavailable state, further comprises:
receiving, by the vehicle control unit, the second control instruction generated by the second chip based on the first environmental perception result in response to the current operating state being the unavailable state.

20. The electronic device according to claim 19, wherein acquiring, by the second chip, the data collected by first sensors comprises:
acquiring, by the second chip, data collected by a first number of first sensors when the state indication information corresponding to the unavailable state is not received; and
receiving, by the second chip, the state indication information corresponding to the unavailable state, and acquiring data collected by a second number of the first sensors, the second number being greater than the first number.
